(19) United States
(12) Patent Application Publication
(10) Pub. No.: US 2023/0404843 A1
(43) Pub. Date: Dec. 21, 2023

(54) MASSAGING SUPPORT

(71) Applicants: ADVANCE KITES S.R.L, SALE MARASINO (BS) (IT); TOSCANA GOMMA S.P.A., ROBBIO (IT)

(72) Inventor: Alessandro MAZZUCCHELLI, SALE MARASINO (BS) (IT)

(73) Assignees: ADVANCE KITES S.R.L., SALE MARASINO (BS) (IT); TOSCANA GOMMA S.P.A., ROBBIO (IT)

(21) Appl. No.: 18/248,298

(22) PCT Filed: Oct. 11, 2021
(86) PCT No.: PCT/IB2021/059278

§ 371 Date: Apr. 7, 2023

(30) Foreign Application Priority Data
Oct. 12, 2020 (IT) 102020000023950

(51) Int. Cl. A61H 9/00

(52) U.S. Cl. CPC A61H 9/0078; A61H 2201/1678; A61H 2201/0149; A61H 2201/1238; A61H 2201/169; A61H 2201/5056

(57) ABSTRACT

Massaging support including: a contact surface for a user, the contact surface including an oscillating area, at least one collapsible element, inside the massaging support and placed below each oscillating zone, the collapsible element including: an inner portion including elastically compressible material, to allow geometric variation of the oscillating zone, a casing, including the inner portion and including a gas-tight membrane, and volume variation apparatus for extracting and/or introducing gas into the enclosure, and including: a pump exclusively for extracting gas from the casing, a valve, for allowing or blocking the introduction of gas into the casing, the massaging support further including controller, to repeat several times, on command, the operations of: in a first half-period of time to contract one of the collapsible elements, placing it in depression, and, in a second half-period of time, to open the valve and expand the collapsible element.

The present invention relates to a massaging support of the type specified in the preamble of the first claim.

In particular, the massaging support is a seat, more particularly for vehicles, or a small bed or similar.

Various types of massaging supports are currently known, such as seats, sometimes included in vehicles, small beds and similar.

The massage supports are very elaborated. They must in fact guarantee the user's comfort for many hours and correct movement of the backrest or cushion.

For example, automotive seats may include an adjustable lumbar support, an adjustable position, an adjustable backrest angle and other features.

The known art described includes some important drawbacks.

In particular, the massage supports can only be used in the massage phase and are not comfortable in other situations.

Consequently, it is impossible to use a massaging support for a long period, since a continuous massage would not be comfortable and that the support itself is not comfortable except during the massage phase.

For example, it is problematic to include the massage supports to the seats for motor vehicles or motor vehicles or to the armchairs or other.

However, a massage vehicle seat should be implemented. In fact, in vehicles, users remain seated for a long time, often with very limited possibilities of movement, and despite the considerable possible adjustments, the driving position, especially if maintained for several hours, is not always comfortable.

In fact, as is known, the human body is made to move and vary in position and, consequently, to vary the type of stress that the back and limbs receive.

Even the continuous use of the pedals does not help the comfort of the user. The driver's legs, glutes and lower back are in fact continuously stressed in the same way by the necessary pressure of the pedals, in particular the pressure of the accelerator is continuous and non-stop.

In this situation, the technical task underlying the present invention is to devise a seat for a vehicle or similar capable of substantially obviating at least part of the aforementioned drawbacks.

Within the scope of said technical task, it is an important object of the invention to obtain a massage support which is comfortable even inactive and used as a stable support, seat or small bed.

Another important technical object is to obtain a massaging support which is a vehicle seat and which is comfortable even when not active.

The technical task and the specified aims are achieved by a vehicle seat and the similar as claimed in the annexed claim 1.

Preferred technical solutions are highlighted in the dependent claims.

The characteristics and advantages of the invention are clarified below by the detailed description of preferred embodiments of the invention, with reference to the accompanying drawings, in which:

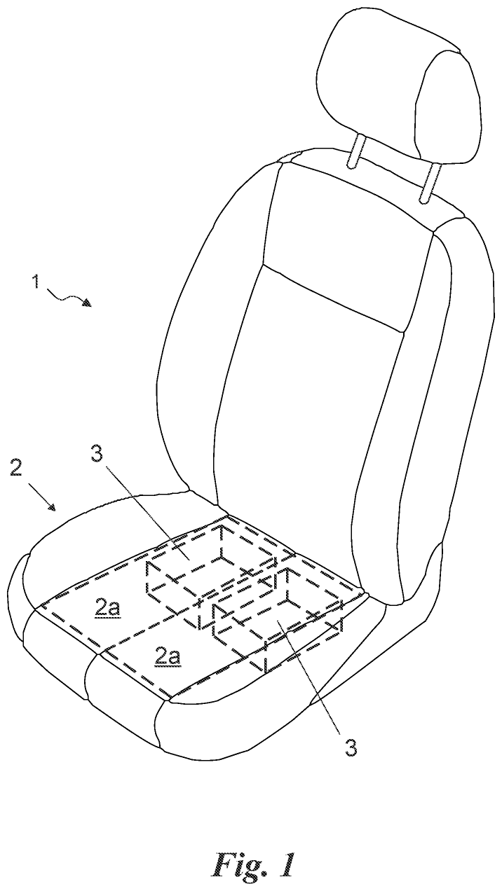

the FIG. 1 shows a vehicle seat according to the invention,

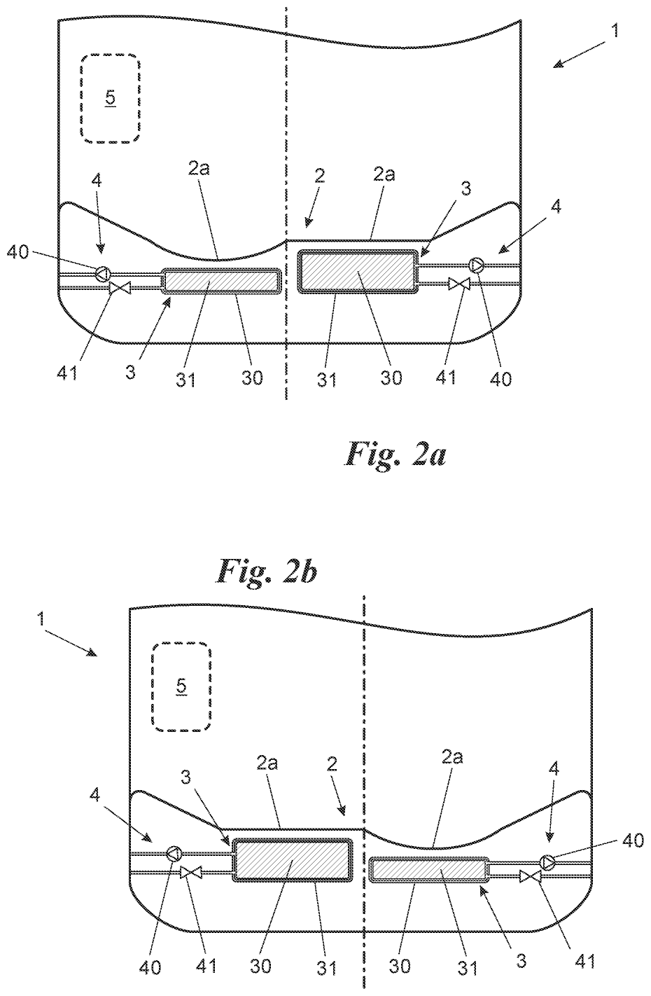

the FIG. 2a schematizes a section of the seat for the vehicle according to the invention, in a first configuration; and

the FIG. 2b schematizes a section of the seat for the vehicle according to the invention, in a second configuration.

In the present document, the measurements, values, shapes and geometric references (such as perpendicularity and parallelism), when associated with words like “about” or other similar terms such as “approximately” or “substantially”, are to be considered as except for measurement errors or inaccuracies due to production and/or manufacturing errors, and, above all, except for a slight divergence from the value, measurements, shape, or geometric reference with which it is associated. For instance, these terms, if associated with a value, preferably indicate a divergence of not more than 10% of the value.

Moreover, when used, terms such as “first”, “second”, “higher”, “lower”, “main” and “secondary” do not necessarily identify an order, a priority of relationship or a relative position, but can simply be used to clearly distinguish between their different components.

Unless otherwise specified, as results in the following discussions, terms such as “treatment”, “computing”, “determination”, “calculation”, or similar, refer to the action and/or processes of a computer or similar electronic calculation device that manipulates and/or transforms data represented as physical, such as electronic quantities of registers of a computer system and/or memories in, other data similarly represented as physical quantities within computer systems, registers or other storage, transmission or information displaying devices.

The measurements and data reported in this text are to be considered, unless otherwise indicated, as performed in the International Standard Atmosphere ICAO (ISO 2533:1975).

With reference to the Figures, the massaging support according to the invention is globally indicated with the number 1.

It is preferably a seat or a small bed or other support. It is more preferably adapted to be inserted inside a vehicle, and more particularly a motor vehicle or a motor vehicle, more particularly the driver's seat. The invention therefore also describes a vehicle, and more particularly a motor vehicle comprising a massaging support 1. The massaging support 1 preferably comprising a contact surface 2 for the body of a user. This contact surface 2 can be the seating of a seat, preferably of a vehicle, or a bed or the backrest of a seat or even more.

The contact surface 2 preferably comprises at least one oscillating area 2a, for example the area of a seat or a backrest of a seat or of a bed.

Preferably the zones are in a plurality and more preferably they are even in number, for example symmetrical with respect to the sagittal plane 1a of the support 1. For example, there may be two oscillating zones 2a on a seating of a seat, one on the right and one on the left, in this example said oscillating zones 2a are adapted to support the glutes of the user of the seat. In a second example, the oscillating zones 2a e are arranged with specular symmetry with respect to the sagittal plane 1a and are present on the back of a seat in the lumbar region, for example they are four in number. There may be oscillating zones on the backrest and more.

The oscillating zones 2a, preferably, do not define structural subdivisions on the surface but are simply an ideal subdivision into two parts of the surface 20.

The contact surface 2 can also contain a single oscillating zone 2a, however it is advantageous for the zones 2a to move with reciprocating movement and therefore are even in number or in any case a plurality.

The massaging support 1 also preferably comprises at least one collapsible element 3, inside the massaging support 1 and placed under an oscillating zone 2a, more preferably there is a collapsible element 3 for each oscillating zone 2a.

The collapsible elements 3 are preferably deflatable and can be placed in depression so as to vary geometrically, or rather to modify the shape, of the contact surface 2 and in particular of the zones 2a. They are preferably at a distance of less than 2 dm from the contact surface 1a, more preferably less than 1 dm and more preferably between 1 cm and 5 cm.

They preferably each comprise an inner portion 30 made of deformable polymeric material, an external casing 31, including the portion 30, consisting of a flexible gas-tight membrane.

Said inner portion 30 is preferably made of polymeric foam or expanded polymeric material or in any case of elastically compressible and preferably polymeric material. For example, they are made of polyurethane foam or other material. Preferably, the inner portion 30 is immersed in a volume of the massaging support 1 in turn, preferably made of a material with properties very similar to the material properties of the inner portion 30 and preferably of the same material.

The outer casing 31 is preferably made of a flexible gas-tight polymer, such as films of polymeric material and similar.

Preferably the inner portion 30 can have different shapes, in particular in top view of a surface similar in size and shape to the surface occupied by a buttock of the driver when seated on the seat 1, and in variable height, when not compressed or expanded and preferably between 1 cm and 1 dm.

The casing 31 preferably surrounds in contact and without wrinkles or overlaps said inner portion 30 when this is expanded. It is preferably in a per se known gas impermeable polymeric membrane. The casing 31 has the purpose of containing the inner portion 30 and allowing the pneumatic sealing of the latter from the external environment.

The massaging support 1 also preferably comprises the volume variation means 4 of the inner portion 30, preferably suitable for extracting and/or introducing gas into the casing 31.

The collapsible element 3a is therefore available in a configuration compressed, in which it is in depression, preferably at least 0.3 bar under the ambient pressure and more preferably at least 0.5 bar under the ambient pressure, and in an expanded configuration, wherein it is preferably at ambient pressure.

The volume variation means 4 can be of various types. Advantageously, they exploit, in particular for the increase in volume, the natural tendency of the material to return to its original shape, or elastic return.

Preferably, the volume variation means 4 comprise a pump 40 adapted at least to extract gas from the casing 31. More preferably, the pump 40 is exclusively adapted to extract gas and, more preferably, there are no active means for the insertion of gas into the casing 31. Logically, the extraction of gas from the casing 31 results in the compression of the inner portion 30, due to the ambient pressure, and therefore a modification of the surface of the oscillating zone 2a, for example a lowering of dimension as illustrated in FIGS. 2a and 2b.

Preferably, the volume variation means 4 comprise a valve 41, adapted to allow or block the introduction of gas into the casing 31, preferably from the external environment. The valve 41 is preferably normally open and is closed only when gas is extracted from the casing 31. It is also preferably a solenoid valve.

To return the collapsible element 3a to its expanded configuration, or of greater volume, it is preferable to simply leave the valve 41 open by exploiting the elastic return of the inner portion 30.

The massaging support 1 also preferably comprises control means 5, for example comprising electronic means such as an Arduino Microcomputer® or similar, configured to repeat several times, on command, the operations of: in a first half-period of time, expand or contract a first collapsible element 3, then placing it in depression, and, in a second half—time period, expand the collapsible element 3. The two half-periods can have durations of the expansion and contraction operation, during which usually the properties of the elements will be intermediate between the expanded and compressed configuration, which can be variable, from being essentially instantaneous to occupying the entire half-period.

The control means 3, the volume variation means 24 and also other elements may possibly also not be structurally integrated with the seat 1 itself and, for example, included in the control unit of the car or similar.

The remaining portion of the seat 1 is of a per se known type.

The operation of the massaging support 1 previously described in structural terms is as follows.

It defines an innovative deformation method of a massaging support 1, preferably applied to vehicles but also to seats or chairs for interiors and exteriors.

The method is preferably applied on the massaging support 1 described above and whose preferred applications are described.

The method comprises, in situations of non-activation of the massage of the support 1, the non-activity of the pump 40 and the opening of the valve 41. In such situations, the support 1 can therefore be used as the standard supports and the presence of the collapsible elements 30, being free to flow the air, it does not alter the physical-mechanical characteristics of the support 1 itself, which can therefore be designed to be comfortable regardless of its massaging properties.

The method includes the periodic and repeated alternation of a first half-period with a second half-period.

In a first half-period of time, the collapsible element 3 is compressed, bringing it into a compressed configuration. This compression occurs by closing the normally closed valve 41 on command and expelling, by means of the pump 40 and any ducts, the gas present in the casing 31. The casing 31 then collapses under the ambient pressure.

In a second half-period the collapsible element 3 is brought into an expanded configuration. This expansion occurs by opening the valve 41, which preferably takes place by removing the previously entered closing command, and by switching off the pump 40, or in any case by deactivating it, in a neutral and unstressed configuration, therefore the massaging support 1 is in an expanded configuration. In this configuration, the air, pushed by atmospheric pressure, enters the casing 31 through the valve 41 and any ducts. The collapsible element 3 then resumes its original shape or expanded configuration.

With the expansion and contraction of the collapsible elements 3, the relative zones change in height or hardness, giving the user the massage.

As previously mentioned, the two half-periods can have durations of the expansion and contraction operation, during which usually the properties of the elements will be intermediate between the expansion and contraction configuration, which can be variable, from being substantially instantaneous to occupy the entire semi-period. Preferably, the complete expansion and compression period of one of the collapsible elements 3 is comprised between 2 s and 20 s, more preferably between 3 s and 9 s.

The periods are preferably constant but could also vary according to pre-selected patterns or randomly.

Furthermore, as previously mentioned, when the collapsible elements 3 are arranged symmetrically, with specular symmetry, with respect to the sagittal plane 1a, the movements are alternated: while a collapsible element 3 is in a contracted configuration, its mirror counterpart is in an expanded configuration.

Different collapsible elements 3 can also work in unison for a different type of massage or also, alternatively to achieve a different weight distribution in the seat, for example to offer a lower passenger position with respect to the inclined plane of the seat or simply to adapt the shape of the seat to the shape of the glutes.

The massaging support 1 and the deformation method of the massaging support 1 according to the invention achieve important advantages.

In fact, when the massage support 1 does not use the massage function, the support 1 works perfectly as a standard support, for example as a standard chair or small bed.

The support can therefore be used and kept deactivated even for a long time and used occasionally, as can happen with car chairs, office or home chairs or beds for the sick or healthy or even more.

Moreover, said alternation of the characteristics of the symmetrical zones 2a on the seating of a seat, in particular if there are two in number, cause the alternating and repeated stimulation of the buttocks of the user, in particular of the driver of the vehicle. This stimulation reproduces the alternating stimulation that the user has while walking and greatly improves his comfort.

In particular, the massage is very advantageous on vehicles and more particularly on motor vehicles, more particularly still for the driver, who has to operate the pedals continuously.

Even on motor vehicles, massage is very advantageous.

Important advantages have also been identified in other situations not only on vehicles. For example, important anti-decubitus properties of the described system have been highlighted.

The invention is susceptible of variants falling within the scope of the inventive concept defined by the claims. In this context, all the details can be replaced by equivalent elements and the materials, shapes and dimensions can be any.

1. A massaging support comprising:
a contact surface for a user,
said contact surface comprising an oscillating zone,
and
at least one collapsible element, inside said massaging support and placed under each said oscillating zone,
said collapsible element comprising:
an inner portion comprising elastically compressible material, so to allow the geometric variation of said oscillating zone,
a casing, including said inner portion and comprising a gas-tight membrane, and
volume variation means suitable for extracting and/or introducing gas inside said casing, and including:
a pump adapted exclusively to extract gas from said casing,
a valve, suitable for allowing or blocking the introduction of gas in said casing,
said massaging support in addition comprising control means, configured to repeat several times, on command, the operations of: in a first half-period contracting one of said collapsible elements, putting it in depression, and, in a second half-period of time, opening said valve and expanding said collapsible element.

2. The massaging support according to claim 1, wherein said valve is a normally open solenoid valve.

3. The massaging support according to claim 1, wherein said inner portion comprises elastically compressible material made of a polymeric foam.

4. The massaging support according to claim 1, wherein said inner portion is immersed in a part of said massaging support volume, in turn made of the same material of said inner portion.

5. The massaging support according to claim 1, comprising a sagittal plane and wherein said oscillating zones are arranged with specular symmetry with respect to said sagittal plane.

6. The massaging support according to claim 1, that consists of a seat.

7. The massaging support according to claim 6, wherein said seat comprises said oscillating zones in correspondence with said seat.

8. The massaging support according to claim 7, wherein said seat is a seat inside automobiles or motor vehicles.

9. A method of deforming of a massage support according to claim 1, wherein:
in situations of non-activation of the massage of said massaging support, the non-activity of said pump and the opening of said valve is foreseen.

10. The method according to claim 9, wherein said massaging support comprises a sagittal plane, wherein said oscillating zones are arranged with specular symmetry with respect to said sagittal plane, and wherein said oscillating zones that are specular are activated simultaneously in opposite way.

11. The method according to claim 9, wherein the complete expansion or contraction period of one of said collapsible elements is comprised between 2 s and 20 s.

12. The method according to claim 9, wherein said period is constant.

13. The massaging support according to claim 2, wherein said inner portion comprises elastically compressible material made of a polymeric foam.

14. The massaging support according to claim 13, wherein said inner portion is immersed in a part of said massaging support volume, in turn made of the same material of said inner portion.
